(19) United States
(12) Patent Application Publication
(10) Pub. No.: US 2005/0010651 A1
(43) Pub. Date: Jan. 13, 2005

(54) Communication system supporting communication between executable applications

(76) Inventors: Jie Xu, San Diego, CA (US); Rex Wendell Maughan, Murray, UT (US)

Correspondence Address: Alexander J. Burke;Intellectual Property Department, 5th Floor, 170 Wood Avenue South, Iselin, NJ, 08830, US

(21) Appl. No.: 10/886,139

(22) Filed: Jul. 7, 2004

Related U.S. Application Data
(60) Provisional application No. 60/486,011, filed on Jul. 10, 2003.

(51) Int. Cl. G06F 15/16

(52) U.S. Cl. 709/219

(57) ABSTRACT

An adaptive communication system supports communication between Internet and non-Internet compatible executable applications. The adaptive communication system includes a universal resource locator (URL) processor and a communication processor. The URL processor generates a URL incorporating, in a URL data field, information derived from a non-Internet compatible executable application. The communication processor initiates Internet compatible communication and conveys the information derived from the non-Internet compatible executable application in the URL data field to an Internet compatible executable application.

### CROSS-REFERENCE TO RELATED APPLICATIONS

The present application is a non-provisional application of provisional application having Ser. No. 60/486,011 filed by Jie Xu, et al. on Jul. 10, 2003.

### FIELD OF THE INVENTION

The present invention generally relates to communication systems. More particularly, the present invention relates to a communication system supporting communication between executable applications.

### BACKGROUND OF THE INVENTION

An emulator is either hardware circuitry or a software application that performs emulation. Emulation refers to the ability of a program or device to imitate another program or device. For example, communications software packages often include terminal emulation drivers, that enable a personal computer (PC) to emulate a particular type of terminal (e.g., a dumb terminal, which is a terminal without its own microprocessor) so that a person can log on to a remote computer (e.g., mainframe computer) for on line communications.

A web browser is a software application used to locate and display web pages. For example, two popular browsers are Netscape® Navigator® and Microsoft® Internet Explorer®. Both of these browsers are graphical browsers, which means that they can display graphics as well as text. In addition, most modern browsers can present multimedia information, including sound and video, although they require additional plug-in software for some formats.

Generally, the emulator is non-web enabled (i.e., non-Internet communication compatible) and the web browser is web enabled (i.e., Internet communication compatible). For various reasons, including backward compatibility and user preference, it would be desirable for computer systems to have a user interface that provides the emulator and the web browser, rather than only the emulator or only the web browser, as in prior systems. For example, some users prefer a web browser having hyper-links to directly link to external resources. Accordingly, there is a need for a communication system supporting communication between executable applications that overcomes these and other disadvantages of the prior systems.

### SUMMARY OF THE INVENTION

According to one aspect of the present invention, an adaptive communication system supports communication between Internet and non-Internet compatible executable applications. The adaptive communication system includes a universal resource locator (URL) processor and a communication processor. The URL processor generates a URL incorporating, in a URL data field, information derived from a non-Internet compatible executable application. The communication processor initiates Internet compatible communication and conveys the information derived from the non-Internet compatible executable application in the URL data field to an Internet compatible executable application.

### BRIEF DESCRIPTION OF THE DRAWINGS

FIG. 1 illustrates a communication system, in accordance with a preferred embodiment of the present invention.

FIG. 2 illustrates a general communication method for the communication system, as shown in FIG. 1, in accordance with a preferred embodiment of the present invention.

FIG. 3 illustrates a particular communication method for the communication system, as shown in FIG. 1, in accordance with a preferred embodiment of the present invention.

FIG. 4 illustrates a user interface window of a non-web enabled application using terminal emulation, for the system and method of FIGS. 1 and 2, respectively, in accordance with a preferred embodiment of the present invention.

FIG. 5 illustrates a user interface window of a non-web enabled application in a web-enabled environment, for the system and method of FIGS. 1 and 2, respectively, in accordance with a preferred embodiment of the present invention.

FIG. 6 illustrates a user interface window of an external web resource accessed from a non-web enabled application in a web-enabled environment, as shown in FIG. 5, in accordance with a preferred embodiment of the present invention.

### DETAILED DESCRIPTION OF THE PREFERRED EMBODIMENTS

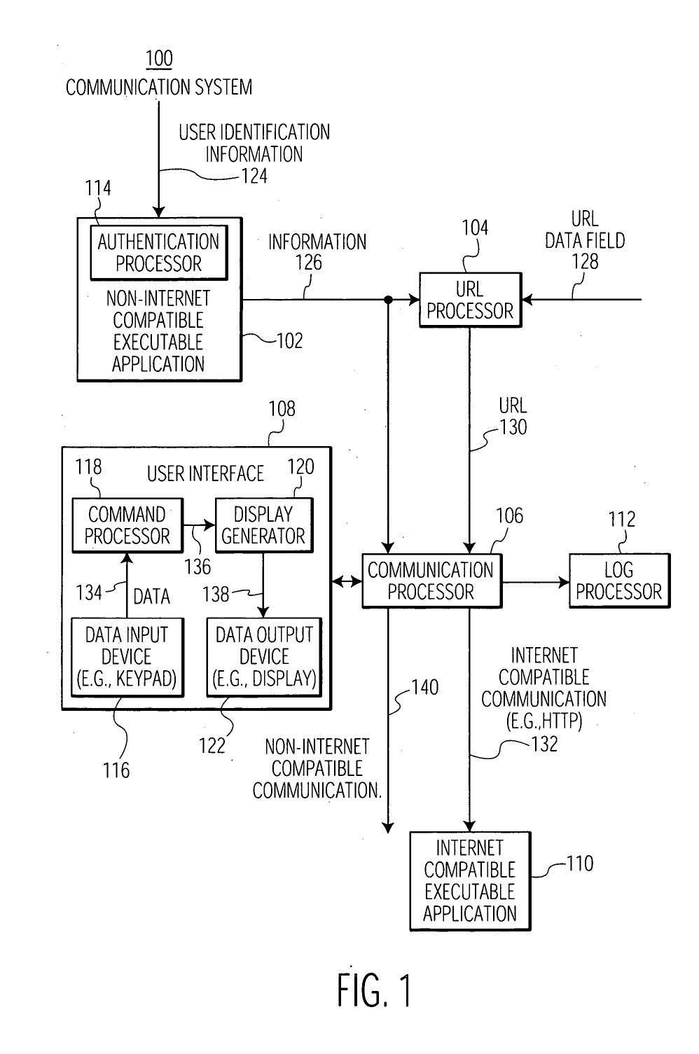

FIG. 1 illustrates a communication system (“system”) 100. The system 100 includes a non-Internet compatible executable application 102, a universal resource locator (“URL”) processor 104, a communication processor 106, a user interface 108, an Internet compatible executable application 110, and a log processor 112. The non-Internet compatible executable application 102 further includes an authentication processor 114. The user interface 108 further includes a data input device 116, a command processor 118, a display generator 120, and a data output device 122.

Generally, the non-Internet compatible executable application 102 receives user identification information 124 and generates information 126. The URL processor 104 receives the information 126 and a URL data field 128 and generates a URL 130. The communication processor 106 communicates with the user interface 108 and the log processor 112. The communication processor also receives the URL 130 and generates an Internet compatible communication 132 for the Internet compatible executable application 110.

Any of the functions provided by the system 100 may be implemented in hardware, software, or a combination of both. In the system 100, one or more elements may include one or more processors, such as the authentication processor 114, the URL processor 104, the communication processor 106, the log processor 112, the command processor, and the display generator (otherwise called “display processor”). A processor includes any combination of hardware, firmware, and/or software. A processor acts upon stored and/or received information by computing, manipulating, analyzing, modifying, converting, or transmitting information for use by an executable procedure or an information device, and/or by routing the information to an output device. For example, a processor may use or include the capabilities of a controller or microprocessor.

A processor performs tasks in response to processing an object. An object, as used herein, comprises a grouping of data and/or executable instructions, an executable procedure, or an executable application. An executable application, as used herein, comprises code or machine readable instruction for implementing predetermined functions including those of an operating system, healthcare information system or other information processing system, for example, in response user command or input.

In the user interface 108, the data output device 122 generates data in response to receiving data from the data input device 116 or other activity by the system 100. The data input device 116 is a keyboard, but also may be a touch screen, or a microphone with a voice recognition program, for example. The data output device 122 is a display, but also may be a speaker, for example.

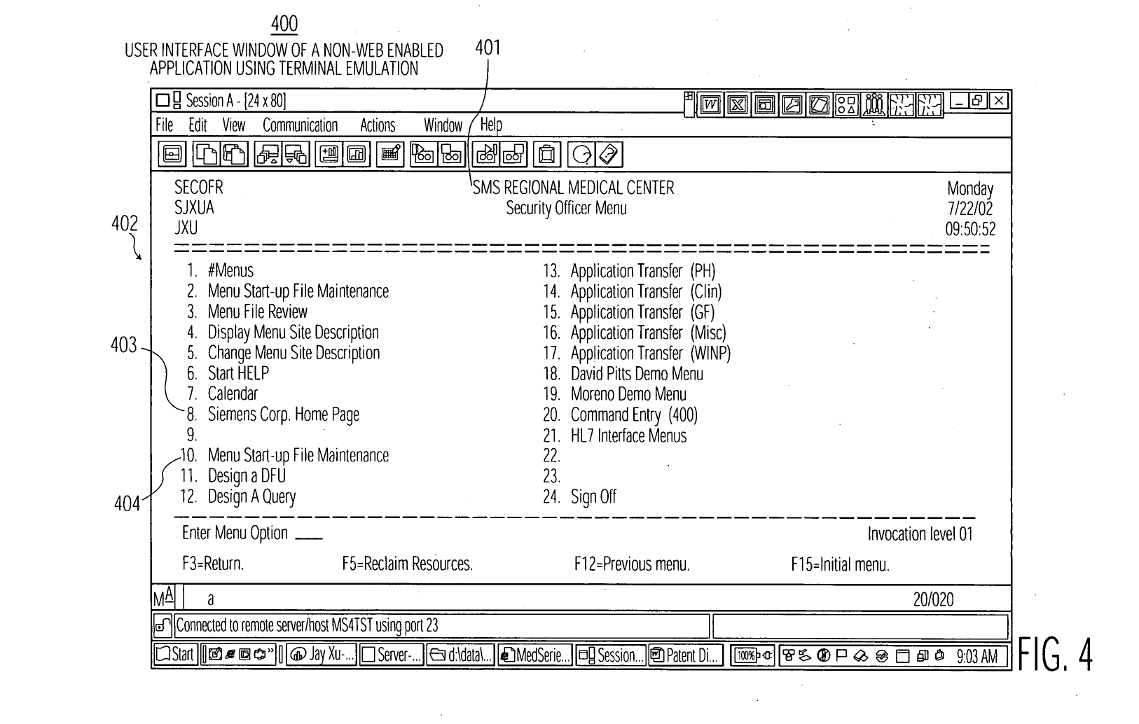

In particular, the data input device 116 provides data to the command processor 118 in response to receiving input information either manually from a user or automatically from an electronic device. The command processor 118 generates commands 136 in response to receiving the data 134. The display generator 120 generates display signals 138, representing display images, in response to receiving the commands 136. A display processor or generator 120 is a known element comprising electronic circuitry or software or a combination of both for generating display images or portions thereof. The data output device 122 generates display images in response to receiving the display signals 138. A user interface comprises one or more display images enabling user interaction with a processor or other device. For example, the user interface 108 provides one or more display images, as shown in FIGS. 4-6, enabling user interaction with the system 100.

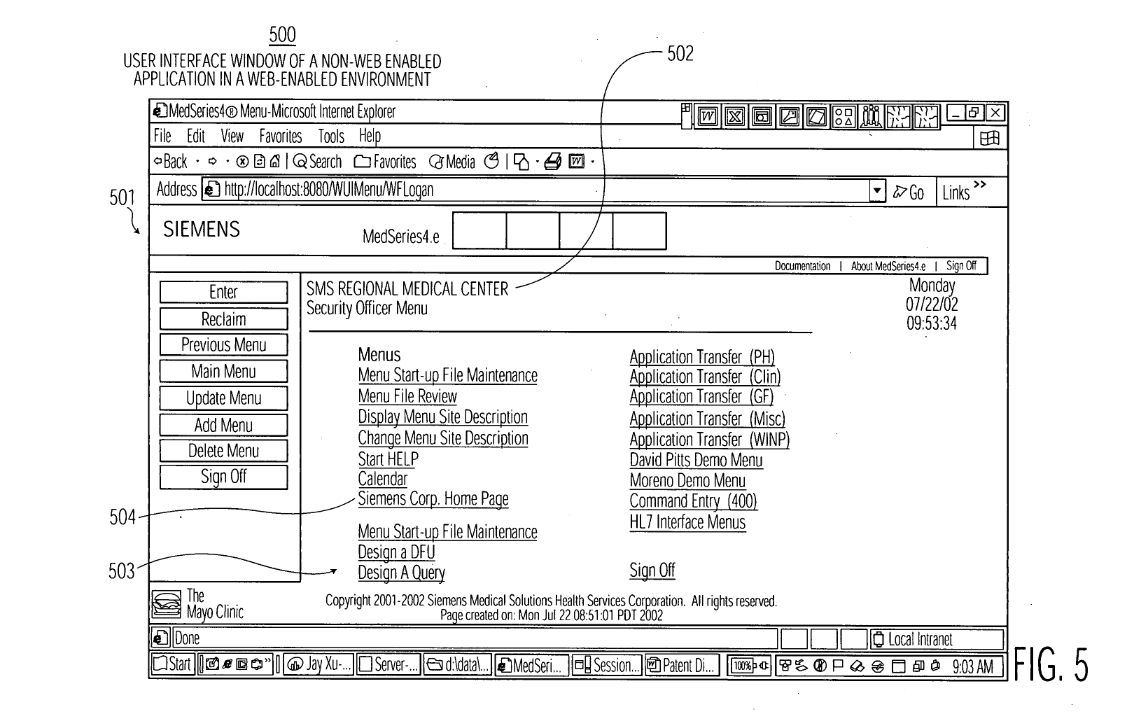

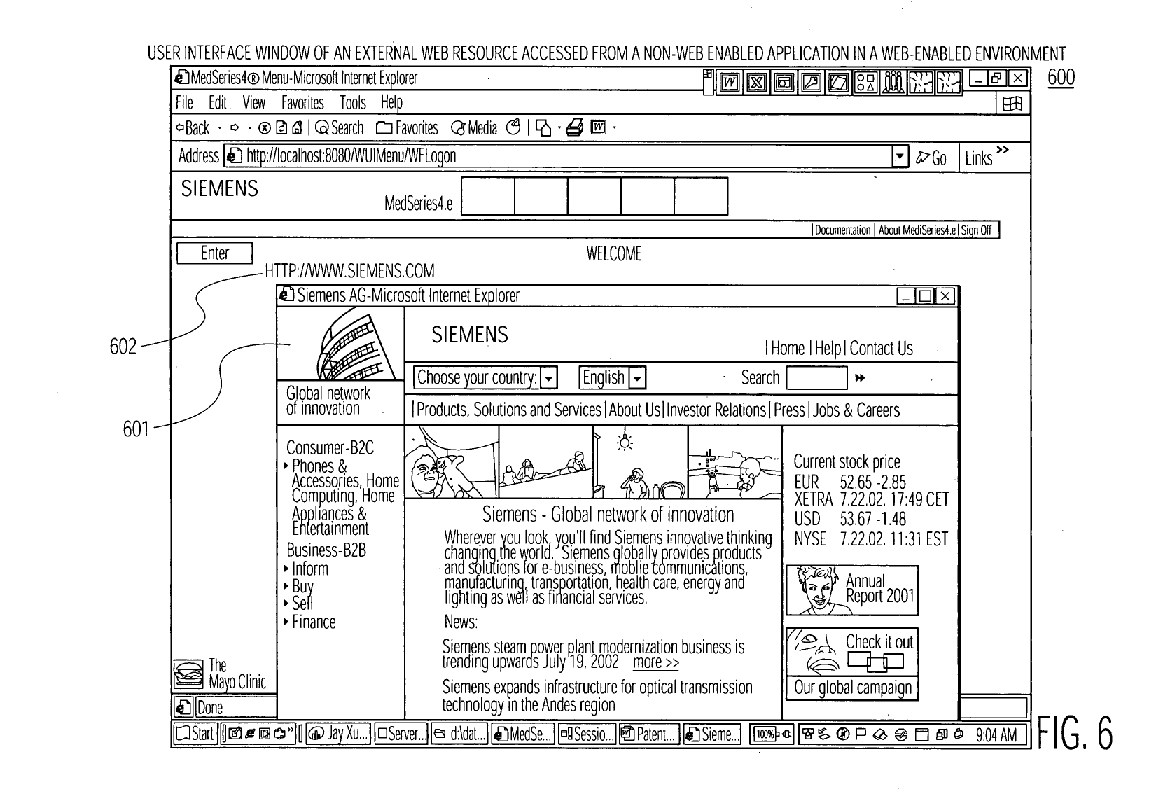

The user interface 108 provides a graphical user interface (GUI), as shown in FIGS. 4-6, wherein at least portions of the data input device 116 and at least portions of the data output device 122 are integrated together to provide a user-friendly interface. For example, a web browser, as shown in FIGS. 5 and 6, forms a part of each of the data input device 116 and the data output device 122 by permitting information to be entered into the web browser and by permitting information to be displayed by the web browser.

The system 100 is intended for use by a healthcare provider that is responsible for servicing the health and/or welfare of people in its care. A healthcare provider may provide services directed to the mental, emotional, or physical well being of a patient. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. The healthcare provider is a hospital. When servicing a person in its care, a healthcare provider diagnoses a condition or disease, and recommends a course of treatment to cure the condition, if such treatment exists, or provides preventative healthcare services. Examples of the people being serviced by a healthcare provider include, without limitation, a patient, a resident, a client, a user, and an individual.

The system 100 provides an electronic mechanism for a healthcare provider (otherwise called a “worker” or “user”) to access healthcare information. The system 100 may be fixed or mobile (i.e., portable), and may be implemented in a variety of forms including, without limitation, a personal computer (PC), a desktop computer, a laptop computer, a workstation, a network-based device, a personal digital assistant (PDA), a smart card, a cellular telephone, a pager, and a wristwatch. The system 100 may be implemented in a centralized or decentralized configuration.

The healthcare information may be represented in a variety of file formats including, without limitation and in any combination, numeric files, text files, graphic files, video files, audio files, and visual files. The graphic files include a graphical trace including, for example, an electrocardiogram (EKG) trace, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

The system 100 communicates with remote computer systems over a wired or wireless communication path. The term “path” may otherwise be called a network, a link, a channel, or a connection. The communication path may use any type of protocol (otherwise called data format) including, without limitation, an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, a Digital and Imaging Communications (DICOM) protocol, and an Health Level Seven (HL7) protocol.

The system 100 is compatible with an International Business Machine (“IBM”) AS/400 system, for example, wherein the AS/400 system is well known in the art of computing systems. The AS/400 system is an IBM minicomputer for small business and departmental users, released in 1988 and still in production under the name iSeries. The AS/400 system is an object-oriented system with an integrated database. The necessary software to run the AS/400 system is included and integrated. Features of the AS/400 system include a menu-driven interface, multi-user support, terminals and printers (using IBM 5250 emulation), security, communications and an extensive library-based operating system, OS/400. The AS/400 system continues to be used today because the hardware abstraction layer (“HAL”) of its micro-code allows the operating system and application programs to take advantage of advances in hardware and software without recompilation. Programming languages available for the AS/400 system include RPG, assembly language, C, C++, Java, COBOL, SQL, and REXX. Several CASE tools for the AS/400 system are available such as Synon, AS/SET, and Lansa. In the AS/400 system, commands in the command language (CL) code are prompted and most provide cursor sensitive help to make entering parameters easier. A command typically includes a three-letter verb part and a subject part to assist users in remembering and understanding the CL code, such as for example, CRTUSRPRF (i.e., create user profile), DLTLIB (i.e., delete library), and CPYF (i.e., copy file). Hence, although the AS/400 provides an advantage due to the HAL, some users of the AS/400 system find that a user interface in the form of the CL code is less preferred than a user interface in the form of a web browser.

IBM 5250 emulation permits devices, such as terminals and printers, to communicate with the AS/400 system, as well as System/3X Connectivity, as is well known in the art. For example, IBM 5250 emulation permits a personal computer (PC) having a microprocessor to emulate a “dumb terminal” that does not have a microprocessor so that the PC can access the AS/400 system. In particular, IBM 5250 Express Program Version 4.0 for DOS, uses an Express Data Stream to provide fast, easy to use, 5250 emulation for connection to the AS/400 system when used with an IBM 5250 Express ISA, PCI, or PCMCIA adapter.

According to one aspect of the present invention, the system 100 supports communication between Internet and non-Internet compatible executable applications. The system 100 is considered adaptive because the system 100 supports communication between the two applications. The system 100 includes the URL processor 104 and the communication processor 106. The URL processor 104 generates the URL 130 incorporating, in a URL data field 128, information 126 derived from a non-Internet compatible executable application 102. The communication processor 106 initiates Internet. compatible communication 132 and conveys the information 126 derived from the non-Internet compatible executable application 102 in the URL data field 128 to an Internet compatible executable application 110. The communication processor 106 initiates Internet compatible communication 132 using Hyper Text Transfer Protocol (“HTTP”) compatible command requests.

The non-Internet compatible executable application 102 includes the authentication processor 114 for determining whether a user is permitted to access URL information and for inhibiting generation of the URL 130 in response to user identification information 124 acquired by the non-Internet compatible executable application 102. The user identification information includes, for example and without limitation, one or more of: (a) a user identification (“ID”), and (b) a password.

The information 126 derived from the non-Internet compatible executable application 102 includes, for example and without limitation, one or more of: (a) a patient identifier, (b) a medical record number, (c) a patient social security number, (d) a patient visit identifier, (e) a patient encounter identifier, (f) a healthcare provider identifier, (g) a patient insurance coverage identifier, and (h) a government issued health identifier.

The log processor 112 maintains a record of user access to both Internet 110 and non-Internet 102 compatible executable applications. In this case, the log processor 112 maintains an auditable record identifying, in response to an individual access command, (a) a user ID of an accessing user, (b) a source of an access request, (c) an application requested by an access request, (d) a time and date of an access request, (d) information supplied in response to an access request, and (e) an IP address of a requesting device. The log processor 112 also maintains a record of user access to one or more of: (a) URL link addresses (e.g., accessible via element 504 in FIG. 5), (b) the Internet compatible executable application 110.

According to another aspect of the present invention, the URL processor 104 generates the URL 130 incorporating, in the URL data field 128, information 126 derived from the non-Internet compatible executable application 102. The communication processor 106 initiates Internet compatible communication 132 and conveys the information 126 derived from the non-Internet compatible executable application 102 in the URL data field 128 to an Internet compatible executable application 110. The communication processor 106 also initiates non-Internet communication 140 responsive to receiving the information 126. The log processor 112 maintains a record of user access to both Internet 110 and non-Internet 102 compatible executable applications.

According to another aspect of the present invention, the command processor 118 receives data 134 identifying whether a command is one or more of, a first command associated with an Internet compatible executable application 110 and a second command associated with a non-Internet compatible executable application 102. The display generator 120 initiates display of an image (e.g., shown in FIGS. 5-6) including a user selectable element representing a particular URL link (e.g., element 504 in FIG. 5) in response to the first command. The display generator 120 initiates display of an image including a non-user selectable character representation of the particular URL link (e.g., element 403 in FIG. 4) in response to the second command.

The Internet compatible executable application 110 includes, for example and without limitation, one or more of: (a) a web-enabled application, (b) a web browser, (c) an executable application capable of Internet Protocol (IP) communication, and (d) an executable application capable of accessing a web page in response to user selection of a displayed URL representative link. The non-Internet compatible executable application 102 includes, for example and without limitation, one or more of: (i) a non-web enabled application, (ii) an executable application incompatible with a web browser, (iii) an executable application incapable of Internet Protocol (IP) communication, and (iv) an executable application incapable of accessing a web page in response to user selection of a displayed URL link or URL representative link data.

Using the teachings of the present invention, a web user can add external URLs into a non-web enabled menu system 102 (i.e. non Internet communication compatible system, e.g., the AS/400 system) so that a web-enabled menu system 110 can provide direct and easy access to external web resources (e.g., element 503 in FIG. 5). A user of the system 100 has the authority to make such a change, so that the user can use either the non-web enabled menu system 102 or the web-enabled menu system 110. The system 100 permits a non-web enabled menu system 102 to include external hyper-link capability as available via browser-based applications.

The system 100 allows users to create a single menu driver configuration that functions in both a terminal environment and a browser environment. The menu system. provides additional functionality for web links that are not available from a terminal based environment. The system 100 advantageously allows host based applications to preserve common security, individual personalization, and patient context sharing while extending the functionality in web environment. Web-based hyper-links are added in a host application itself and are processed using the security and individual personalization of the host applications. Since web-based hyper-links are embedded in a host application, host application information may also be communicated in HTTP requests (e.g., in URL data fields) provided in these web-based hyper-links.

Web-based hyper-links are defined through a host application. Security functions in the host application control connecting to the web-based hyper-links and passing along patient context information. The security and personalization features in the host application are preserved in the web-based hyper-links. For example, the web-based hyper-links are password protected using password protection capability of a host application. Further, individual users are able customize the web-based hyper-links through host applications. Records identifying individual user system activity are kept on the host based applications and include logging information identifying access to an individual web page directly linked from a host application.

Host applications have the capability of logging (recording and maintaining an auditable trail) of user activity. Web-based hyper-links are embedded in the host application and linking activity is logged within the host application. The initial host link is considered another program invocation by the menu system and is logged (recorded) along with the other program invocations. Host-based applications (based on terminals such as IBM compatible 3270 and 5250 terminals, for example) are limited to presenting content from the host-based applications. These host applications may be “screen scraped” or “translated” to web pages. Although this conversion/translation effort is effective at providing a web based front end, limitations in the underlying host-based applications prevent additional functionality, such as URL linking from host applications in a web environment. However, the system 100 allows host-based applications to preserve common security, individual personalization, and patient context sharing while extending the functionality in the web environment.

The system 100 extends a host application security and individual personalization capability to added web functionality when used in a web environment. The system allows a host-based user to add URL links to host applications and use these links in a web environment while retaining existing security and individualized personalization of host applications. Since these URL links are defined through the host application, security control may be placed on connecting to the linked URLs and passing along patient context information.

Records of individual user system activity, which are typically kept on the host-based applications, now combines logging information to the web page directly linked from the host-based system. Combining the host-based logs with proxy-based logging may also provide full individual user log information for both host-based and web-based activities. The combination of host-based and web-based log information assists health care providers in meeting auditing and security requirements, required by the Health Insurance Portability and Accountability Act (“HIPAA”), for example. The system 100 advantageously links host-translated web pages with native web based application while retaining security, personalization, and a direct link to the same patient selected (e.g., context sharing) in the host-based system.

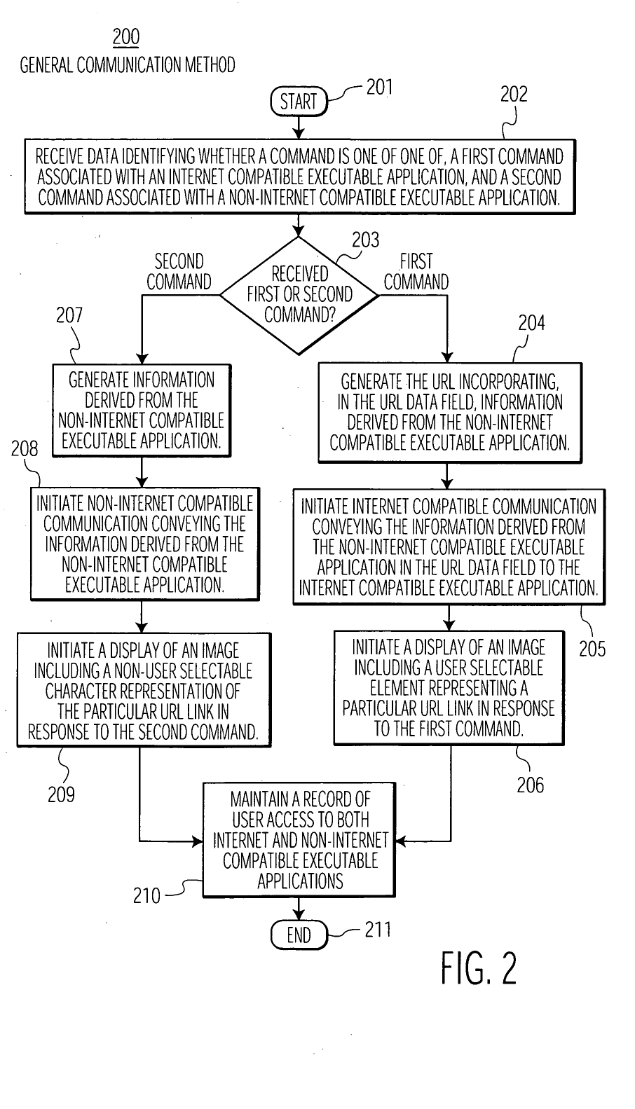

FIG. 2 illustrates a general communication method 200 for the communication system 100, as shown in FIG. 1. Generally, the method 200 permits a menu system of a non-web enabled application (e.g., IBM AS/400 compatible system) to be modified to allow a URL link from a menu item to provide direct access (e.g., hyper-linked) to other web resources. The method 200 supports different actions to be performed based on the kind of user interface desired. For example, if a program is invoked using a PC with a web browser (i.e., a web enabled application 110), then the web browser supports URL links to link the user to the URL content. However, if the same program is invoked using a terminal (i.e., non-web enabled application 102), then the URL reference is simply displayed in character form on the terminal, without hyper-linking capability.

The present method 200 advantageously provides the ability to add URLs to the menu driver of the system 100. With this feature, the menu driver may be configured with the URL of “http://www.siemensmedical.com” when menu option 10 (element 404 in FIG. 4) is selected, for example. When menu option 10 (element 404 in FIG. 4) is selected from a terminal, the URL reference is displayed to allow the user to copy the reference down and use another computer's web browser to access the URL. By contrast, when the menu option (e.g., element 504 in FIG. 5) corresponding to menu option 10 (element 404 in FIG. 4) is selected from the web browser, the URL “http://www.siemensmedical.com” hyper-link is used to automatically display the associated web page 600, as shown in FIG. 6.

At step 201, the method 200 starts.

At step 202, the method 200 receives data identifying whether a command is one of: a first command associated with an Internet compatible executable application 110, and a second command associated with a non-Internet compatible executable application 102. The command may be of any type, kind, length, frequency, duration, etc. The command processor 118, as shown and described in FIG. 1, performs step 202.

At step 203, the method 200 determines whether the data 134, received by the command processor 118, identifies the command as being the first command or the second command. If the method 200 determines that the command processor 118 received the first command, then the method 200 continues to step 204. Otherwise, if the method 200 determines that the command processor 118 received the second command, then the method 200 continues to step 207. The command processor 118, as shown in FIG. 1, makes the determination at step 203.

At step 204, the method 200 generates the URL 130 incorporating, in the URL data field 128, information 126 derived from the non-Internet compatible executable application 102. The URL processor 104, as shown and described in FIG. 1, performs step 203.

At step 205, the method 200 initiates Internet compatible communication 132 conveying the information 126 derived from the non-Internet compatible executable application 102 in the URL data field 128 to the Internet compatible executable application 110. The communication processor 106, as shown and described in FIG. 1, performs step 205.

At step 206, the method 200 initiates display of an image (e.g., image 500 in FIG. 5) including a user selectable element representing a particular URL link (e.g., element 504 in FIG. 5) in response to the first command. The display generator 120 in cooperation with the communication processor 106, as shown and described in FIG. 1, performs step 204.

For example, FIG. 5 shows a user interface window 500 of a non-web enabled application in a web-enabled environment, for the system 100 and method 200 of FIGS. 1 and 2, respectively. The user interface window 500 represents a web browser, as shown and. described in FIG. 1. The window 500 includes a browser template 501, a web page 502, a list of URL links 503, and a particular URL link 504. The browser template 501 includes, without limitation, a company name (e.g., “Siemens”), a program name (e.g., “MedSeries4.e), and menu selections (e.g., “Enter,” “Reclaim,” “Previous Menu,” “Main Menu,” “Update Menu,” “Add Menu,” “Delete Menu,” and “Sign Off.”). The web page 502 includes a menu title (e.g., SMS Regional Medical Center) describing the particular web page displayed within the browser template 501. The list of URL links 503 describes various URL links available within the web page 502. The underlined URL links typically indicate that the URL links a hyper-link to another web page, located inside or external to the web page 502. The particular URL link 504 (e.g., Siemens Corp. Home Page) represents a particular hyper-link to a particular web page.

When a user selects the particular URL link 504, the method causes the data output device 122 to display a web page 601, as shown in FIG. 6. FIG. 6 illustrates a user interface window 600 accessed from a non-web enabled application in a web-enabled environment. The web page includes the URL address 602 for the web page 601 (e.g., “http://www.siemens.com”).

At step 207, the method 200 generates information 126 derived from the non-Internet compatible executable application 102. The non-Internet compatible executable application 102 generates the information 126, as shown and described in FIG. 1.

At step 208, the method 200 initiates non-Internet compatible communication 140 conveying the information 126 derived from the non-Internet compatible executable application 102. The communication processor 106 initiates non-Internet compatible communication 140, as shown and described in FIG. 1.

At step 209, the method 200 initiates display of an image 400 in FIG. 4 including a non-user selectable character representation of the particular URL link (e.g., element 403 menu item 8 in FIG. 4) in response to the second command. The display generator 120 in cooperation with the communication processor 106, as shown and described in FIG. 1, performs step 209. FIG. 4 illustrates a user interface window 400 of a non-web enabled application 102 using terminal emulation, for the system 100 and method 200 of FIGS. 1 and 2, respectively. The window 400 includes a header section 401, a menu section 402 including a particular menu 403, and a start-up menu selection. The header section 401 includes, for example and without limitation, a program title (e.g., “SMS Regional Medical Center”), a menu title (e.g., “Security Officer Menu”), and day, date, and time information (e.g., “Monday, 7/22/02, 09:50:52). The menu section 402 includes a variety of menu options (e.g.; menu options numbered 1-24).

The start-up menu selection is menu option number 10 (e.g., “Menu Start-up File Maintenance”). The method 200 permits a user to set up a list of programs to be called based on the menu selection chosen. For example, the user can set up the menu driver to call “program A” when option 10 is selected. The menu driver program allows user to configure actions to occur when specific options are selected.

At step 210, the method 200 maintains a record of user access to both Internet 110 and non-Internet 102 compatible executable applications. The log processor 112, as shown and described in FIG. 1, performs step 210.

At step 211, the method 200 ends. Various features of the present invention may be combined to form various aspects of the present invention.

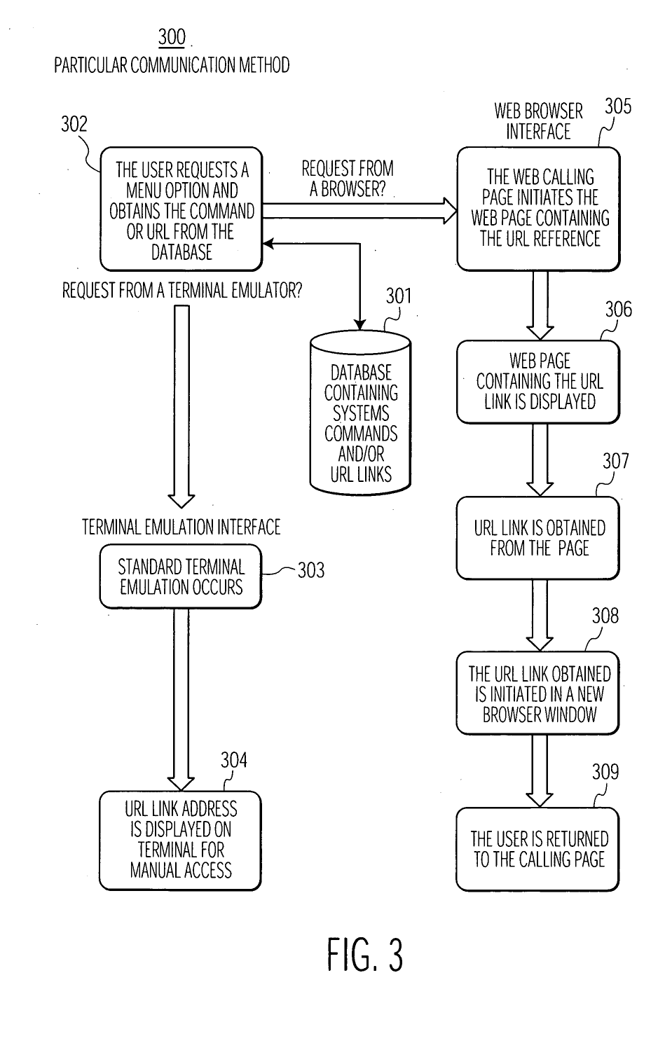

FIG. 3 illustrates a particular communication method 300 for the communication system 100, as shown in FIG. 1.

At step 302, the method 300 receives a request from a user for a menu selection (otherwise called “menu option”). For example, the menu selection may be a non-Internet compatible (e.g., terminal emulator) menu selection (e.g., element 403 in FIG. 4). or an Internet compatible (e.g., web browser) menu selection (e.g., element 504 in FIG. 5). The method 300 retrieves a system command or a URL link, corresponding to the menu selection, stored in a database 301. If the menu selection is the non-Internet compatible menu selection, then the method 300 continues to step 303. Otherwise, if the menu selection is the Internet compatible menu selection, then the method 300 continues to step 305. The user interface 108 receives the request, as shown and described in FIG. 1.

At step 303, the method 300 provides terminal emulation, as is well known to those skilled in the art of terminal/host computer systems.

At step 304, the method 300 provides a URL link address for the user to permit the user to manually access the URL link address. The method 300 displays the URL link address on the display 122 (FIG. 1). For example, the display 122 (FIG. 1) displays a user interface window 400 (FIG. 4) of a non-web enabled application using terminal emulation for the system and method of FIGS. 1 and 2, respectively, as shown and described in FIG. 4. The database 301 (FIG. 3) stores the URL address for menu option number 8 (e.g., “Siemens Corp. Home Page”). In response to a user entering menu option 8 (e.g., “Siemens Corp. Home Page”), via the bottom of the screen entry element, the URL address (e.g. http://www.siemens.com) of Siemens Corp. Home Page is retrieved from the database 301 (FIG. 3) and displayed in character form.

At step 305, the method 300 causes a web-calling page to initiate a web page (e.g., window 500 in FIG. 5) containing the URL link reference (e.g., 504 in FIG. 5).

At step 306, the method 300 displays the web page containing the URL link reference (e.g., 504 in FIG. 5). For example, the user interface 108 (FIG. 1) displays a user interface window 500 (FIG. 5) of a non-web enabled application in a web-enabled environment (e.g., a web browser interface) for the system 100 and method 200 of FIGS. 1 and 2, respectively.

At step 307, the method 300 obtains the URL link 504 in FIG. 5 from the web page 500 in FIG. 5.

At step 308, the method 300 initiates a new browser window 600 in FIG. 6 in response to user selection of the URL link 504 in FIG. 5. For example, FIG. 6 shows the user interface window 600 of an external web resource, as a new browser window 600, accessed from a non-web enabled application 102 in a web-enabled environment (e.g., the web browser). The URL link 403 in FIG. 4 is not accessible using terminal emulation, but provides the user with a genuine browser experience when using a web-enabled legacy application, as shown in FIG. 5.

At step 309, the method 300 returns the user to the calling web page.

The system 100 integrates the IBM AS/400's terminal emulation menu system, for example, with a web-browsing environment and provides a capability to add external URL links to this web-enabled menu system. With the system 100, users of the web-enabled AS400 menu system can add external URL links into the IBM AS/400 menu. The system 100 provides the user with quick and easy access to web resources while preserving the security and user configuration capability of the legacy IBM AS/400 menu system.

The system 100 advantageously extends legacy applications (e.g., IBM AS/400) to a browser-based user interface, by adding portal capabilities with direct web links, and by providing user front-end application integration. The system 100 extends a non-web enabled application menu as a simple, user-defined web portal tool. The system 100 provides a file driven menu system to operate differently if called from a browser than if called from a terminal session. This operational difference permits different content to be displayed to the user depending on the user interface used to call the program.

The system 100 advantageously extends the prior menu systems, which called the IBM 5250 screen displays, by adding the ability to mix IBM 5250 applications with user defined web URL links, wherein end users can pick both the URL address and the corresponding description; by extending the security model for the IBM 5250 application to newly added URL links; by permitting existing customers to use the converted screen and add their choice of URL links; and by providing a low cost “portal type” environment while leveraging existing software and enables front end integration. The system 100 advantageously combines prior terminal screens with conversion and with user definable links and security, which extends the menu tool.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. An adaptive communication system supporting communication between Internet and non-Internet compatible executable applications, comprising:
a URL processor for generating a URL incorporating, in a URL data field, information derived from a non-Internet compatible executable application; and
a communication processor for initiating Internet compatible communication and conveying said information derived from said non-Internet compatible executable application in said URL data field to an Internet compatible executable application.

2. The system according to claim 1, wherein
said communication processor initiates Internet compatible communication using HTTP (HyperText Transfer Protocol) compatible command requests.

3. The system according to claim 1, wherein
said non-Internet compatible executable application includes an authentication processor for determining whether a user is permitted to access URL information and for inhibiting generation of said URL in response to user identification information acquired by said non-Internet compatible executable application.

4. The system according to claim 3, wherein
said user identification information includes at least one of, (a) a user ID and (b) a password.

5. The system according to claim 1, wherein
said information derived from said non-Internet compatible executable application comprises at least one of, (a) a patient identifier, (b) a medical record number, (c) a patient social security number, (d) a patient visit identifier, (e) a patient encounter identifier, (f) a healthcare provider identifier, (g) a patient insurance coverage identifier, and (h) a government issued health identifier.

6. The system according to claim 1, including
a log processor for maintaining a record of user access to at least one of, (a) URL link addresses, (b) said Internet compatible executable application.

7. The system according to claim 1, including
a log processor for maintaining a record of user access to both Internet and non-Internet compatible executable applications.

8. The system according to claim 7, wherein
said log processor maintains an auditable record identifying, in response to an individual access command, (a) a user ID of an accessing user, (b) a source of an access request, (c) an application requested by an access request, (d) a time and date of an access request, (d) information supplied in response to an access request and (e) an IP address of a requesting device.

9. An adaptive communication system supporting communication between Internet and non-Internet compatible executable applications, comprising:
a URL processor for generating a URL incorporating, in a URL data field, information derived from a non-Internet compatible executable application;
a communication processor for initiating Internet compatible communication and conveying said information derived from said non-Internet compatible executable application in said URL data field to an Internet compatible executable application; and
a log processor for maintaining a record of user access to both Internet and non-Internet compatible executable applications.

10. An adaptive user interface system supporting Internet and non-Internet compatible executable applications, comprising:
a command processor for receiving data identifying whether a command is at least one of, a first command associated with an Internet compatible executable application and a second command associated with a non-Internet compatible executable application;
a display generator for initiating display of an image including a user selectable element representing a particular URL link in response to said first command and for initiating display of an image including a non-user selectable character representation of said particular URL link in response to said second command.

11. An adaptive user interface system according to claim 10, wherein
said Internet compatible executable application comprises at least one of, (a) web-enabled application, (b) a web browser, (c) an executable application capable of Internet Protocol (IP) communication and (d) an executable application capable of accessing a web page in response to user selection of a displayed URL representative link and
said non-Internet compatible executable application comprises at least one of, (i) a non-web enabled application, (ii) an executable application incompatible with a web browser, (iii) an executable application incapable of Internet Protocol (IP) communication and (iv) an executable application incapable of accessing a web page in response to user selection of a displayed URL link or URL representative link data.

12. A method supporting communication between Internet and non-Internet compatible executable applications, comprising the activities of:
generating a URL incorporating, in a URL data field, information derived from a non-Internet compatible executable application; and
initiating Internet compatible communication conveying said information derived from said non-Internet compatible executable application in said URL data field to an Internet compatible executable application.

13. A method supporting communication between Internet and non-Internet compatible executable applications, comprising the activities of:
generating a URL incorporating, in a URL data field, information derived from a non-Internet compatible executable application;
initiating Internet compatible communication and conveying said information derived from said non-Internet compatible executable application in said URL data field to an Internet compatible executable application; and
maintaining a record of user access to both Internet and non-Internet compatible executable applications.

14. A method for providing a user interface supporting Internet and non-Internet compatible executable applications, comprising the activities of:
receiving data identifying whether a command is at least one of, a first command associated with an Internet compatible executable application and a second command associated with a non-Internet compatible executable application;
initiating display of an image including a user selectable element representing a particular URL link in response to said first command and for initiating display of an image including a non-user selectable character representation of said particular URL link in response to said second command.
